(19) United States
(12) Patent Application Publication
(10) Pub. No.: US 2026/0220011 A1
(43) Pub. Date: Jul. 30, 2026

(54) CACHE SYSTEMS AND METHODS FOR TRAINING MACHINE LEARNING MODELS

(71) Applicant: Samsung Electronics Co., Ltd., Suwon-si (KR)

(72) Inventors: Omkar DESAI, Syracuse, NY (US); Shuyi PEI, Santa Clara, CA (US); Janki BHIMANI, Miami, FL (US); Bryan KIM, Syracuse, NY (US)

(21) Appl. No.: 19/417,305

(22) Filed: Dec. 11, 2025

Related U.S. Application Data
(60) Provisional application No. 63/751,259, filed on Jan. 29, 2025.

(51) Int. Cl. G06F 11/30; G06N 20/00

(52) U.S. Cl. CPC G06F 11/3055; G06F 11/3037; G06N 20/00

(57) ABSTRACT

An amount of a cache for storing training data in a particular form may be determined based on modeling throughput of a data storage and ingestion pipeline for training machine learning models. The machine learning models may be trained to perform a task using training data in the particular form stored in the cache. A request may be identified for a first instance of the training data in the particular form to include in a training batch. The first instance of the training data in the particular form may not be stored in the cache. A second instance of the training data in the particular form stored in the cache may be determined not to have been used to train the machine learning models. The second instance of the training data in the particular form may be included in the training batch.

### RELATED APPLICATION DATA

This application claims the benefit of U.S. Provisional Patent Application Ser. No. 63/751,259, filed Jan. 29, 2025, which is incorporated by reference herein for all purposes.

### FIELD

The disclosure relates generally to training machine learning models, and more particularly to cache systems and methods for training machine learning models.

### BACKGROUND

Machine learning models are trained to perform a task using training data. Training these models often consumes substantial compute and memory resources.

The above information disclosed in this Background section is for enhancement of understanding the background of the disclosure and therefore this Background section may contain subject matter that does not constitute prior art.

### BRIEF DESCRIPTION OF THE DRAWINGS

The drawings described below are examples of how embodiments of the disclosure may be implemented, and are not intended to limit embodiments of the disclosure. Individual embodiments of the disclosure may include elements not shown in particular figures and/or may omit elements shown in particular figures. The drawings are intended to provide illustration and may not be to scale.

FIG. 1 illustrates a system including servers with resources for training machine learning models, according to embodiments of the disclosure.

FIG. 2 illustrates a representation of a data storage and ingestion pipeline, according to embodiments of the disclosure.

FIG. 3 illustrates a representation of modeling throughput of a data storage and ingestion pipeline, according to embodiments of the disclosure.

FIG. 4 illustrates a representation of cache systems for training machine learning models, according to embodiments of the disclosure.

FIG. 5A illustrates a representation of a request for training data from a cache, according to embodiments of the disclosure.

FIG. 5B illustrates a representation of a response to a request for training data according to embodiments of the disclosure.

FIG. 6 shows a flowchart of an example procedure for training a first machine learning model to perform a task and training a second machine learning model to perform the task, according to embodiments of the disclosure.

FIG. 7 shows a flowchart of an example procedure for training a first machine learning model to perform a task, according to embodiments of the disclosure.

FIG. 8 shows a flowchart of an example procedure for training machine learning models to perform a task, according to embodiments of the disclosure.

### SUMMARY

An amount of a cache for storing training data in a particular form may be determined based on modeling throughput of a data storage and ingestion pipeline for training machine learning models. The machine learning models may be trained to perform a task using training data in the particular form stored in the cache. A request may be identified for a first instance of the training data in the particular form to include in a training batch. The first instance of the training data in the particular form may not be stored in the cache. A second instance of the training data in the particular form stored in the cache may be determined not to have been used to train the machine learning models. The second instance of the training data in the particular form may be included in the training batch.

An amount of the cache for storing training data in a particular form may be determined based on a characteristic of a training dataset. A request may be identified for a first instance of the training data in the particular form to include in a training batch. The first instance of the training data in the particular form may not be stored in the cache. A second instance of the training data in the particular form stored in the cache may be determined not to have been used to train a machine learning model. The second instance of the training data in the particular form may be included in the training batch. The machine learning model may be trained to perform a task using the training batch.

Throughput of a data storage and ingestion pipeline for training machine learning models may be modeled. An amount of a cache for storing training data in a particular form may be selected based on modeling the throughput of the data storage and ingestion pipeline. The machine learning models may be trained to perform a task using the training data in the particular form stored in the cache. A request may be identified for a first instance of the training data in the particular form to include in a training batch. The first instance of the training data in the particular form may not be stored in the cache. A second instance of the training data in the particular form stored in the cache may be determined not to have been used to train the machine learning models. The second instance of the training data in the particular form may be included in the training batch.

### DETAILED DESCRIPTION

Reference will now be made in detail to embodiments of the disclosure, examples of which are illustrated in the accompanying drawings. In the following detailed description, numerous specific details are set forth to enable a thorough understanding of the disclosure. It should be understood, however, that persons having ordinary skill in the art may practice the disclosure without these specific details. In other instances, well-known methods, procedures, components, circuits, and networks have not been described in detail so as not to unnecessarily obscure aspects of the embodiments.

It will be understood that, although the terms first, second, etc. may be used herein to describe various elements, these elements should not be limited by these terms. These terms are only used to distinguish one element from another. For example, a first module could be termed a second module, and, similarly, a second module could be termed a first module, without departing from the scope of the disclosure.

The terminology used in the description of the disclosure herein is for the purpose of describing particular embodiments only and is not intended to be limiting of the disclosure. As used in the description of the disclosure and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The components and features of the drawings are not necessarily drawn to scale.

Substantial compute and memory resources are consumed in training machine learning models to perform tasks involving digital images, recommendations, digital videos, and other types of digital content. The compute and memory resources are typically consumed as part of a data storage and ingestion pipeline. At the beginning of the data storage and ingestion pipeline, training data for training the machine learning models is included in storage (e.g., remote storage).

Next in the pipeline, the training data is accessed from storage and then modified into a form usable for training the machine learning models. At the end of the data storage and ingestion pipeline, the machine learning models are trained using the modified training data. In some embodiments, throughput (e.g., samples per second) of the data storage and ingestion pipeline may contribute significantly to overall machine learning model training performance.

In order to improve such performance, throughput of the data storage and ingestion pipeline is modeled based on amounts of different forms of training data stored in a cache within the pipeline. In some embodiments, the training data may be modified into a first form, a second form, or a third form within the data storage and ingestion pipeline. For instance, the training data in the first form may include encoded training data (e.g., digital images), the training data in the second form may include decoded training data (e.g., tensors), and the training data in the third form may include augmented training data (e.g., rotated images as tensors). It is to be appreciated that, in some embodiments, determining the amounts of the different forms of training data to store in the cache is not always intuitive because, for example, the training data in the first form generally occupies less space in the cache than the training data in the third form but the training data in the third form is ready for training the machine learning models while the training data in the first form needs additional processing before it is usable for training.

In some embodiments, a model of throughput of the data storage and ingestion pipeline may include/incorporate (e.g., as inputs) characteristics of other systems/devices that are part of the pipeline. For instance, the data storage and ingestion pipeline includes the cache and a first processor to manage accesses to the cache. Accordingly, the model of throughput may include/incorporate characteristics of the cache (e.g., a size/capacity, a bandwidth, and other characteristics) as well as characteristics of the first processor (e.g., speed/throughput converted to samples per second).

In some embodiments, the model of throughput of the data storage and ingestion pipeline may include/incorporate characteristics of a training dataset that includes the training data in storage at the beginning of the pipeline. Characteristics of the training dataset may include a size of the training dataset, a total number of samples included in the training dataset, an average size of the samples included in the training dataset, and other characteristics. In some embodiments, the model of throughput includes characteristics of a network (e.g., a bandwidth). In some embodiments, the model may include/incorporate characteristics of a machine learning model and/or characteristics a second processor that trains the machine learning model at the end of the data storage and ingestion pipeline. Characteristics of the second processor may be similar to characteristics of the first processor while characteristics of the machine learning model may include a model size, a model type, and other characteristics.

In some embodiments, the model of throughput is implemented to determine a first amount of the cache for storing the training data in the first form, a second amount of the cache for storing the training data in the second form, and a third amount of the cache for storing the training data in the third form. For instance, the amounts of the different forms of training data stored in the cache may be determined to maximize throughput of the data storage and ingestion pipeline or another metric affecting the performance of training the machine learning models. Notably, in an example in which the amounts of the different forms of training data stored in the cache are determined to maximize the throughput of the data storage and ingestion pipeline, this improvement increases training efficiency of each machine learning model trained using the different forms of training data stored in the cache. In order to further improve the performance of training the machine learning models, the training data in the cache may be sampled in a manner which improves a rate at which data requested from the cache “hits” the cache (e.g., data is received from the cache).

In some embodiments, data in the cache may be randomly sampled to be combined into batches of training data for training the machine learning models. In an example, the first processor may be configured to request (or receive a request for) a first instance of training data from the cache. In this example, the first instance of training data is not available in the cache; however, a second instance of training data is available in the cache.

In some embodiments, the first processor may access metadata including a use status indicator for the second instance of training data. If the use status indicator does not indicate that the second instance of training data has already been used to train the machine learning models, then the requested first instance of training data may be replaced with the second instance of training data. The second instance of training data can then be included in a training batch and used to train the machine learning models. In some embodiments, the metadata also includes a use count for the second instance of training data which is incremented based on using the second instance of training data to train the machine learning models. If a number of uses of the second instance of training data exceeds a threshold number of uses, then the second instance of training data can be marked for eviction from the cache.

By replacing the first instance of training data requested from the cache with the second instance of training data available in the cache, the described systems improve the “hit” rate for the cache. This increases efficiency of preparing batches of training data without adversely impacting training results because the use status indicator prevents a sample of training data from being reused in a training epoch. Additionally, determining the amounts of the different forms of training data to store in the cache improves throughput of the data storage and ingestion pipeline and/or other metrics that affect machine learning model training performance.

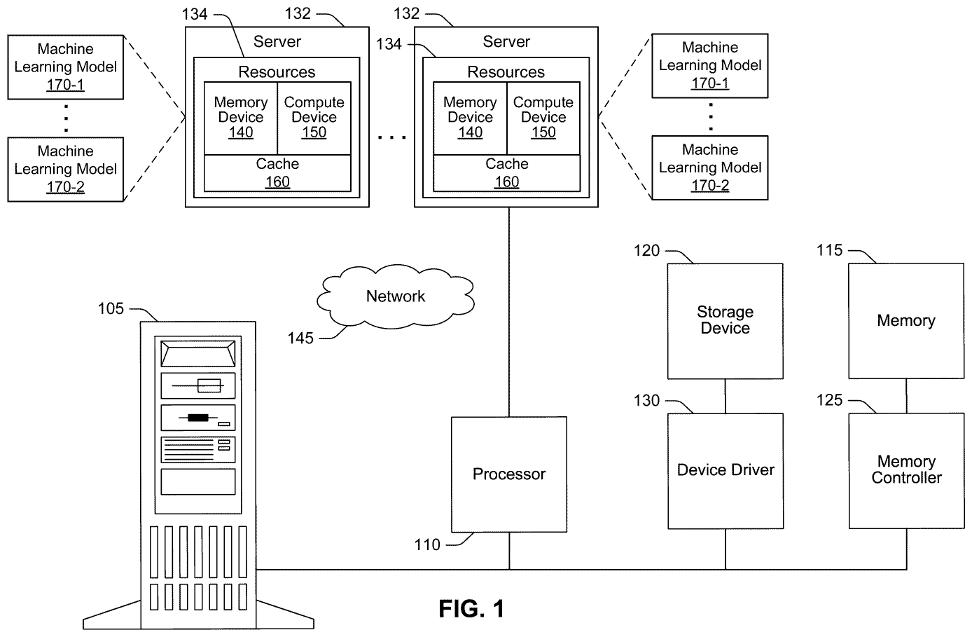

FIG. 1 illustrates a system including servers 132 with resources 134 for training machine learning models 170-1, 170-2, according to embodiments of the disclosure. As shown in FIG. 1, a machine 105 (e.g., a host) includes a processor 110, a memory 115, and a storage device 120. The processor 110 can include a variety of types of processors such as central processing units (CPUs), accelerators, graphics processing units (GPUs), processors implemented using field-programmable gate arrays (FPGAs) (e.g., soft processors), and other types of processors. The memory 115 can include volatile memory and/or non-volatile memory and the memory 115 is representative of a variety of types of memory, including, but not limited to, read only memory (ROM), random access memory (RAM), static RAM (SRAM), dynamic RAM (DRAM), synchronous DRAM (SDRAM), combinations thereof, and the like.

A memory controller 125 may manage read/write operations performed using the memory 115. In the illustrated example, the processor 110 is communicatively coupled to the memory controller 125 via a wired or wireless connection. The processor 110 is also shown to be communicatively coupled to the storage device 120 via a device driver 130. The device driver 130 can control the storage device 120 and the device driver 130 may be implemented using software, hardware, or a combination of software and hardware.

The system shown in FIG. 1 is illustrated to include servers 132 having resources 134 (e.g., compute and/or memory resources) that may be communicatively coupled to the machine 105 via a wired or wireless connection. By way of example, the processor 110 may be connected to the servers 132 via a network 145 (e.g., a wi-fi network, a wide area network, a local area network, a cellular network, or other types of networks). In some embodiments, the resources 134 include one or more memory devices 140, one or more compute devices 150, and one or more caches 160.

A memory device 140 may include one or more memories such as volatile memories and/or non-volatile memories. In some embodiments, a cache 160 may include one or more memories such as RAM, DRAM, and/or other types of memory. For instance, the cache 160 may be configured to temporarily store training data to be used for training first and second machine learning models 170-1, 170-2 to perform a task.

A compute device 150 may include one or more processors such as CPUs, accelerators, GPUs, neural processing units (NPUs), tensor processing units (TPUs), and other types of processors. In some embodiments, the compute device 150 may include a first processor (e.g., a CPU) for managing read/write operations performed using the cache 160, a second processor (e.g., a GPU) for training the first machine learning model 170-1 to perform a task using training data read from the cache 160, and a third processor (e.g., a GPU) for training the second machine learning model 170-2 to perform the task using training data read from the cache 160. For instance, the compute device 150 may include an additional processor for training an additional machine learning model to perform the task using training data read from the cache 160.

In some embodiments, the first and second machine learning models 170-1, 170-2 are to be trained to perform the task using a same set of training data which may be stored in a memory of the memory device 140. In one example, the task is an object detection task and the set of training data includes digital images depicting objects. In another example, the task is an audio mixing task and the set of training data includes digital audio recordings.

In some embodiments, a portion of the set of training data may be included in the cache 160. It is to be appreciated that, in some embodiments, a particular sample from the set of training data may be in different forms (e.g., encoded, decoded, or augmented) and the different forms may consume different amounts of memory in the cache 160. As described further below, amounts of the cache 160 for storing training data in different forms may be determined based on a model of various systems/components involved in training the first and second machine learning models 170-1, 170-2.

In order to train the first and second machine learning models 170-1, 170-2 to perform the task, a particular sample of the set of training data should be used once per epoch (a complete pass of the set of training data) for training each of the first and second machine learning models 170-1, 170-2. The particular sample of the set of training data may be used to train the first machine learning model 170-1 and the second machine learning model 170-2. For instance, the particular sample can be used to train the first and second machine learning models 170-1, 170-2 by including the particular sample in a training batch. One epoch for training the first and second machine learning models 170-1, 170-2 may include one or more training batches. Also, the particular sample of the set of training data should not be reused across epochs. Additionally, an order in which samples of the set of training data are used to train the first and second machine learning models 170-1, 170-2 should be random (e.g., unordered). As described further below, training data may be sampled from the cache 160 using metadata to track whether or not the particular sample of the set of training data has been used in an epoch and how many times the particular sample has been used to train the first and second machine learning models 170-1, 170-2.

In some embodiments, the amounts of the cache 160 for storing training data in different forms may be determined to maximize throughput of the various systems/components involved in training the first and second machine learning models 170-1, 170-2. In these embodiments, maximizing the throughput of the various systems/components generally decreases a training time for training the first and second machine learning models 170-1, 170-2. For instance, decreasing the training time improves an efficiency of training the first and second machine learning models 170-1, 170-2 and may conserve some compute/memory resources and/or decrease power consumption. Additionally, in some embodiments, the machine learning model training guidelines described above may be applied to techniques for sampling training data used to train the first and second machine learning models 170-1, 170-2. In these embodiments, the first and second machine learning models 170-1, 170-2 may be trained with improved sampling efficiency which is described further below.

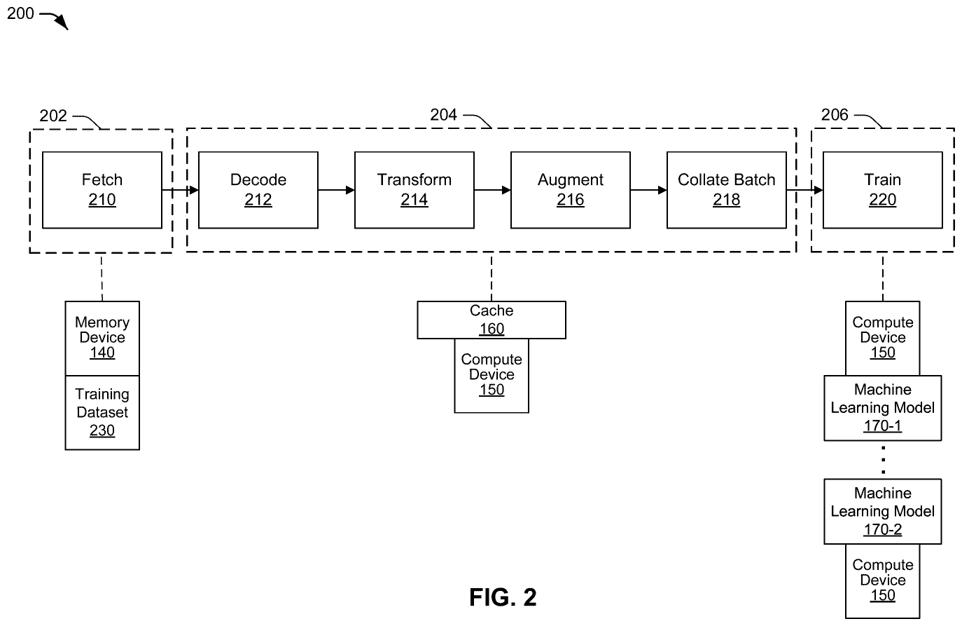

FIG. 2 illustrates a representation of a data storage and ingestion pipeline 200, according to embodiments of the disclosure. As shown, a data storage and ingestion pipeline 200 illustrates example systems/processes involved in preparing training data for training the first and second machine learning models 170-1, 170-2. The data storage and ingestion pipeline 200 is illustrated to include a first stage 202, a second stage 204, and a third stage 206.

At the first stage 202, a fetch operation 210 may fetch (e.g., read) training data from a training dataset 230 included in storage such as a memory of a memory device 140 in the illustrated example. The training data read from the training dataset 230 in storage may be encoded (e.g., as digital images, digital audio samples, or other types of encodings). In some embodiments, at the second stage 204, a decode operation 212 may decode the encoded training data into tensors (e.g., arrays).

After the decode operation 212 within the second stage 204, a transform operation 214 may transform the tensors into a form that is processable by the first and second machine learning models 170-1, 170-2. It is to be appreciated that, in some embodiments, the transform operation 214 may be different for different types of training data and models. For instance, the transform operation 214 may tokenize text, resize images, quantize audio, and perform other transformations for other types of data.

As shown in FIG. 2, after the transform operation 214, an augment operation 216 may augment the transformed tensors to increase diversity in the training data for training the first and second machine learning models 170-1, 170-2. Increasing diversity in the training data may reduce overfitting and improve generalization for the first and second machine learning models 170-1, 170-2. Similar to the transform operation 214, in some embodiments, the augment operation 216 may be different for different types of training data and models. For example, the augment operation 216 may mask portions of text, rotate images, time stretch audio, and perform other augmentations for other types of data.

After the augment operation 216, within the second stage 204, a collate batch operation 218 may arrange augmented training data samples into groups (e.g., pairs) or batches of particular samples. In some embodiments, the particular samples may be labeled for inclusion together within a batch. At the collate batch operation 218, a batch of training data samples is finalized and transmitted to the third stage 206.

At the third stage 206, a train operation 220 is performed using a batch of training data to train the first and second machine learning models 170-1, 170-2 to perform a task. As shown in FIG. 2, a first compute device 150 trains the first machine learning model 170-1 to perform the task using the batch of training data. As further shown, a second compute device 150 trains the second machine learning model 170-2 to perform the task using the batch of training data. Consider an example in which the batch of training data may be temporarily stored in the cache 160 such that the batch of training data can be efficiently transmitted to the third stage 206. In this example, if additional instances of training data usable to form additional batches of training data are also temporarily stored in the cache 160, then the additional batches of training data may also be efficiently transmitted to the third stage 206. In some embodiments, efficiently transmitting batches of training data to the third stage 206 may improve an overall efficiency of training the first and second machine learning models 170-1, 170-2 to perform the task.

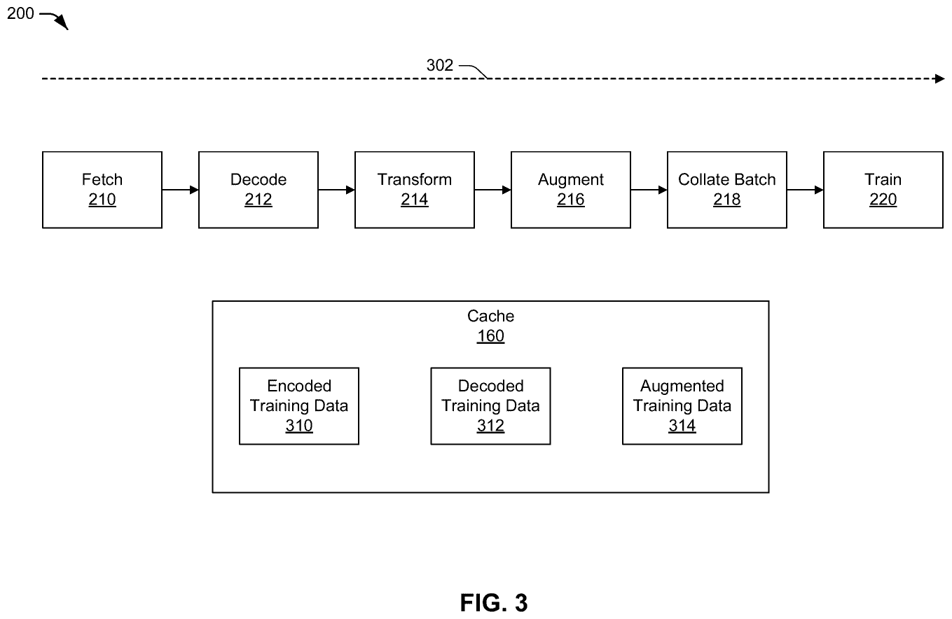

FIG. 3 illustrates a representation of modeling throughput 302 of a data storage and ingestion pipeline 200, according to embodiments of the disclosure. The representation depicts the cache 160 which includes training data from the training dataset 230 in a first form, a second form, and a third form. As shown in FIG. 3, the cache 160 is illustrated to include encoded training data 310, decoded training data 312, and augmented training data 314.

A relationship between throughput 302 (samples per second) of the data storage and ingestion pipeline 200 and an amount of each of the encoded training data 310, the decoded training data 312, and the augmented training data 314 included in the cache 160 may be multivariate and non-linear. In some embodiments, the relationship between throughput 302 and the amount of each of the encoded training data 310, the decoded training data 312, and the augmented training data 314 included in the cache 160 may be based on one or more characteristics of a memory device 140 (e.g., a memory capacity), a compute device 150 (e.g., CPU/GPU availability), the training dataset 230 (e.g., a size, a total number of samples, an average size of samples, or other training dataset 230 characteristics), the first and second machine learning models 170-1, 170-2 (e.g., model size/type), the network 145 (e.g., network bandwidth), and/or other systems/devices. In some embodiments, characteristics of the training dataset 230 may include a type of training data (e.g., digital images, text, digital video, digital audio, or other types), whether or not training samples are labeled, whether the training dataset 230 is static (e.g., fixed) or dynamic (e.g., changing/increasing), a dimensionality of the training dataset 230 (e.g., a number of features per training sample), a data distribution of the training dataset 230 (e.g., a number of classes/distributions), and other characteristics.

As shown in FIG. 3, the throughput 302 depends on time spent fetching data (e.g., performing the fetch operation 210 in the first stage 202), preprocessing the data (e.g., in the second stage 204), and processing the data (e.g., in the third stage 206). For instance, including the augmented training data 314 in the cache 160 generally decreases time preprocessing the data (e.g., in the second stage 204) whereas including the encoded training data 310 in the cache 160 generally increases time preprocessing the data. However, including the augmented training data 314 in the cache 160 generally increases time spent fetching data (e.g., in the first stage 202) based on, for example, the larger tensor size of the augmented training data 314.

Accordingly, modeling throughput 302 of the data storage and ingestion pipeline 200 may be accomplished by modeling portions of the data storage and ingestion pipeline 200. The modeled portions can then be combined to model the relationship between throughput 302 and amounts of the training data in the first form (e.g., the encoded training data 310), the second form (e.g., the decoded training data 312), and the third form (e.g., the augmented training data 314) included in the cache 160. In some embodiments, gradient communication overhead for the model (e.g., after each training batch to synchronize gradients across all training processors) may be computed separately based on a number of training nodes (e.g., one node for the first machine learning model 170-1 and one node for the second machine learning model 170-2). In some embodiments, overhead for a training batch may be represented by:

$$\frac{2 \times ( n - 1 )}{n} \times β N$$

where: n refers to a number of nodes (or processors per node); and βN refers to a model size in megabytes.

In some embodiments, units of throughput 302 (samples per second) are used in modeling system units for ease of calculation/representation. In some embodiments, accessing the augmented training data 314 from the cache 160 may be represented as:

$${DSI}_{A} = min ( \frac{{B}_{cache}}{M \times {S}_{data}} , \frac{n \times {B}_{NIC}}{( M \times {S}_{data} ) + {C}_{nw}} , \frac{n \times {B}_{PCIe}}{( M \times {S}_{data} ) + {C}_{PCIe}} , n \times {T}_{GPU} )$$

where: DSI_{A} refers to performance (e.g., samples per second) of the data storage and ingestion pipeline 200 for accessing the augmented training data 314 from the cache 160; B_{cache} refers to a maximum bandwidth of the cache 160 (bytes per second); M refers to a size inflation factor for preprocessed data; S_{data} refers to a size of an encoded sample (bytes); n refers to a number of training nodes; B_{NIC} refers to network 145 bandwidth per training node (bytes per second); Cn, refers to internode gradient communication overhead (bytes); B_{PCIe} refers to per node Peripheral Component Interconnect Express (PCIe) bandwidth (bytes per second); C_{PCIe} refers to intranode gradient communication overhead (bytes); and T_{GPU} refers to per node processor (e.g., compute device 150) ingestion throughput (samples per second). It is to be appreciated that interconnect examples such as PCIe and interface examples such as network interface cards are non-limiting interconnect/interface examples.

As described above, the augmented training data 314 is stored in the cache 160 which may also include the encoded training data 310 and the decoded training data 312. In some embodiments, a probability of accessing the augmented training data 314 from the cache 160 may be represented as:

$${N}_{A} = min ( {N}_{total} , \frac{{x}_{A} \times {S}_{mem}}{M \times {S}_{data}} )$$

where: N_{A} refers to a number of samples in the augmented training data 314; Nₜₒₜₐₗ refers to a total number of samples in the training dataset 230; x_{A} refers to an amount of the cache 160 allocated to store the augmented training data 314; and Sₘₑₘ refers to a size of an augmented sample (bytes).

In some embodiments, accessing the decoded training data 312 from the cache 160 may be represented as:

$${DSI}_{D} = min ( \frac{{B}_{cache}}{M \times {S}_{data}} , \frac{n \times {B}_{NIC}}{( M \times {S}_{data} ) + {C}_{nw}} , n \times {T}_{A} , \frac{n \times {B}_{PCIe}}{( M \times {S}_{data} ) + {C}_{PCIe}} , n \times {T}_{GPU} )$$

where: DSI_{D} refers to performance (e.g., samples per second) of the data storage and ingestion pipeline 200 for accessing the decoded training data 312 from the cache 160; and T_{A} refers to per node processor throughput for augmenting data (samples per second).

In some embodiments, a probability of accessing the decoded training data 312 from the cache 160 may be represented as:

$${N}_{D} = min ( {N}_{total} - {N}_{A} , \frac{{x}_{D} \times {S}_{mem}}{M \times {S}_{data}} )$$

where: N_{D} refers to a number of samples in the decoded training data 312; and X_{D} refers to an amount of the cache 160 allocated to store the decoded training data 312.

In some embodiments, accessing the encoded training data 310 from the cache 160 may be represented as:

$${DSI}_{E} = min ( \frac{{B}_{cache}}{M \times {S}_{data}} , \frac{n \times {B}_{NIC}}{( M \times {S}_{data} ) + {C}_{nw}} , n \times {T}_{D + A} , \frac{n \times {B}_{PCIe}}{( M \times {S}_{data} ) + {C}_{PCIe}} , n \times {T}_{GPU} )$$

where: DSI_{E} refers to performance (e.g., samples per second) of the data storage and ingestion pipeline 200 for accessing the encoded training data 310 from the cache 160; and T_{D+A} refers to per node processor throughput for decoding and augmenting data (samples per second).

In some embodiments, a probability of accessing the encoded training data 310 from the cache 160 may be represented as:

$${N}_{E} = min ( {N}_{total} - ( {N}_{A} + {N}_{D} ) , \frac{{x}_{E} \times {S}_{mem}}{{S}_{data}} )$$

where: N_{E} refers to a number of samples in the encoded training data 310; and x_{E} refers to an amount of the cache 160 allocated to store the encoded training data 310.

In some embodiments, accessing data from storage (e.g., the memory device 140) may be represented as:

$${DSI}_{s} = min ( {DSI}_{E} , \frac{{B}_{storage}}{{S}_{data}} )$$

where: DSIₛ refers to performance (e.g., samples per second) of the data storage and ingestion pipeline 200 for accessing data from storage (e.g., the memory device 140); and B_{storage} refers to a maximum storage bandwidth (bytes per second).

In some embodiments, a number of samples of the training dataset 230 included in storage (e.g., the memory device 140) may be represented as:

$${N}_{storage} = {N}_{total} - {N}_{A} - {N}_{D} - {N}_{E}$$

where: N_{storage} refers to a number of samples from the training dataset 230 included in storage (e.g., the memory device 140) which is assumed to be the portion of the training dataset 230 that does not fit in the cache 160.

In some embodiments, throughput 302 of the data storage and ingestion pipeline 200 may be modeled as a combination of the models described above which may be represented as:

$${DSI}_{overall} = \frac{{N}_{A}}{{N}_{total}} \times {DSI}_{A} + \frac{{N}_{D}}{{N}_{total}} \times {DSI}_{D} + \frac{{N}_{E}}{{N}_{total}} \times {DSI}_{E} + \frac{{N}_{storage}}{{N}_{total}} \times {DSI}_{S}$$

where: DSIₒᵥₑᵣₐₗₗ refers to throughput 302 (samples per second) of the data storage and ingestion pipeline 200.

In some embodiments, throughput 302 of the data storage and ingestion pipeline 200 can be estimated for different amounts of the training data in the first form (e.g., the encoded training data 310), the second form (e.g., the decoded training data 312), and the third form (e.g., the augmented training data 314) included in the cache 160. It is to be appreciated that, in some embodiments, the models described above may be leveraged to optimize (e.g., maximize or minimize) one or more variables such as an amount of a particular form of the training data included in the cache 160. Accordingly, the described systems are not limited to improving a particular metric such as throughput 302. Instead, the described systems may be utilized to improve a variety of different metrics for different types of training and different types of models.

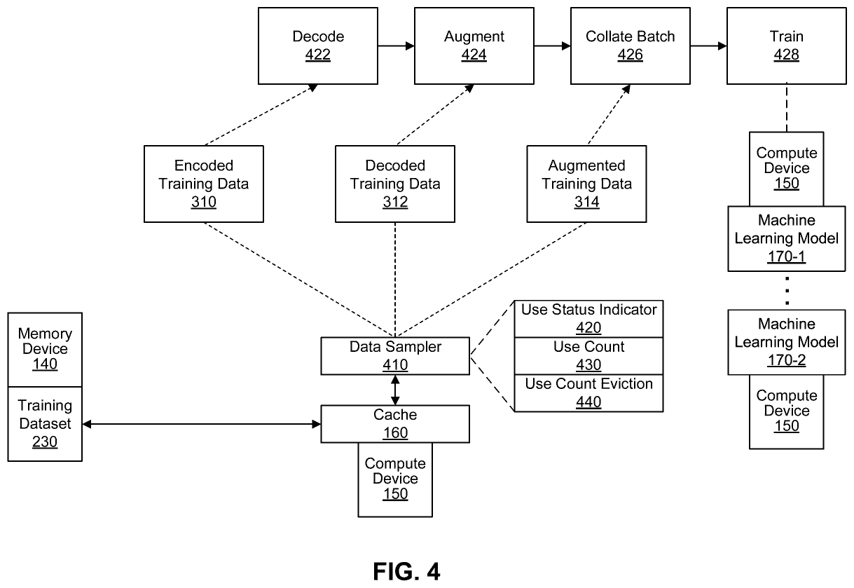

FIG. 4 illustrates a representation of cache systems for training machine learning models 170-1, 170-2, according to embodiments of the disclosure. As shown, the representation includes the training dataset 230 in storage (e.g., a memory of the memory device 140) and the cache 160. In some embodiments, a first amount of the cache 160 stores the encoded training data 310, a second amount of the cache 160 stores the decoded training data 312, and a third amount of the cache 160 stores the augmented training data 314. It is to be appreciated that, in some embodiments, the first, second, and/or third amounts may be determined based on a characteristic of the cache 160 (e.g., a total capacity), a characteristic of the first machine learning model 170-1 (e.g., a model size), a characteristic of the training dataset 230 (e.g., an average sample size), a characteristic of a processor included in a compute device 150 used to train the first machine learning model 170-1 to perform a task, and/or other characteristics.

As shown in FIG. 4, the representation also includes a data sampler 410 configured to randomly sample training data from the cache 160 because an order in which samples of the training dataset 230 are used to train the first and second machine learning models 170-1, 170-2 should be random (e.g., unordered). For instance, if the samples of training data from the training dataset 230 are ordered (e.g., not random), then the ordering may adversely affect the training of the first and second machine learning models 170-1, 170-2 which may “learn” the ordering rather than to perform the task. The randomly sampled training data is then used for training the first and second machine learning models 170-1, 170-2. The data sampler 410 may be implemented in hardware, software, or a combination of hardware and software and the data sampler 410 can be included in a compute device 150 communicatively coupled to the cache 160. Since the data sampler 410 randomly samples training data from the cache 160, the sampled data may include encoded training data 310, decoded training data 312, or augmented training data 314 as illustrated in FIG. 4.

In some embodiments, the augmented training data 314 is directly usable for training the first and second machine learning models 170-1, 170-2. In the illustrated example, the augmented training data 314 is transmitted to a collate batch operation 426 in which a batch of training data samples is finalized. After finalization, a train operation 428 is performed using the batch of training data samples to train the first and second machine learning models 170-1, 170-2 to perform a task.

As shown, the decoded training data 312 is transmitted to an augment operation 424. In some embodiments, the augment operation 424 augments the decoded training data 312 (e.g., as augmented training data 314) before the collate batch operation 426. For instance, the encoded training data 310 is initially transmitted to a decode operation 422 that decodes the encoded training data 310 (e.g., as decoded training data 312) before the augment operation 424 and the collate batch operation 426.

The data sampler 410 is illustrated to include a use status indicator 420, a use count 430, and a use count eviction 440. In order to ensure that a particular training data sample is used once per training epoch, the use status indicator 420 may be configured to indicate whether the particular training data sample has been used in an epoch. After the epoch, the use status indicator 420 may be reset. Consider an example in which the use status indicator 420 for the particular training data sample is unset (e.g., set to zero) and then the particular training data sample is used in a first training batch of a training epoch. In this example, after the first training batch, the use status indicator 420 for the particular training data sample is set (e.g., set to one) and the particular training data sample is not used in a second training batch of the training epoch based on the use status indicator 420. Once the training epoch is complete, the use status indicator 420 for the particular training data sample may be reset (e.g., set to zero).

In some embodiments, the compute device 150 may be configured for resetting the use status indicator 420 after training the first and second machine learning models 170-1, 170-2 to perform the task. Additionally, the use count 430 for the particular training data sample may be configured to indicate a number of times that a request for the particular training data sample is received from or “hits” the cache 160. It is to be appreciated that, in some embodiments, the use count 430 may be maintained across epochs In some embodiments, if the use count 430 for the particular training data sample reaches a predefined threshold number of uses (e.g., due to the random sampling), then the compute device 150 can use the use count eviction 440 to mark the particular training data sample for eviction from the cache 160 (e.g., removal from the cache 160 by a background thread).

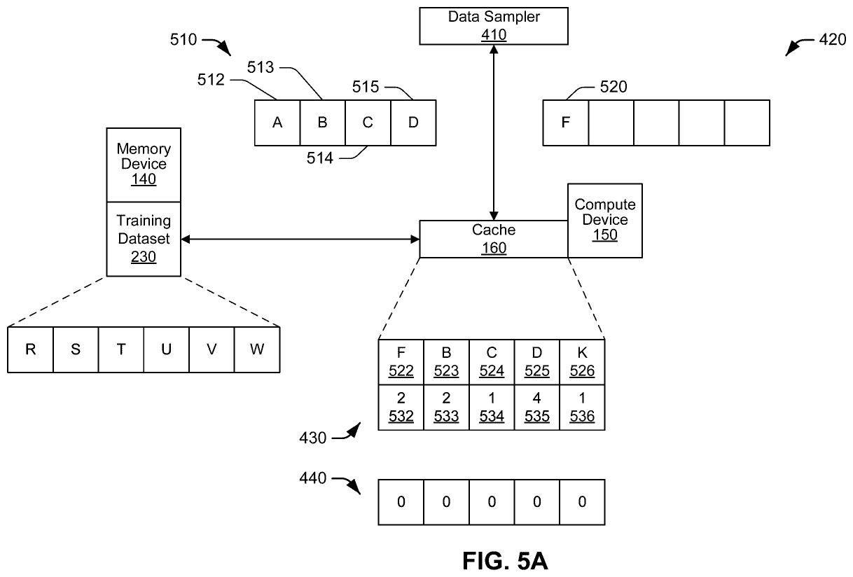

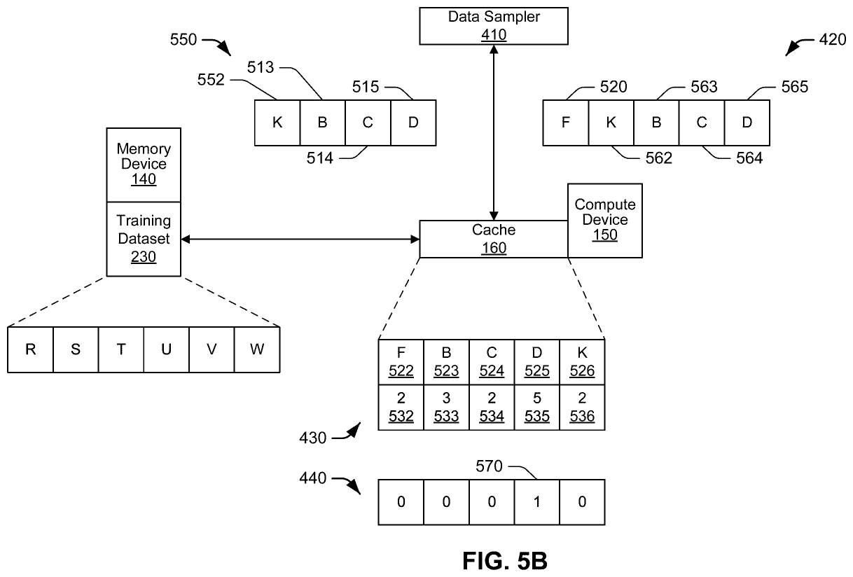

FIG. 5A illustrates a representation of a request 510 for training data from a cache 160, according to embodiments of the disclosure. The representation is illustrated to include representations of the use status indicator 420, the use count 430, and the use count eviction 440. As shown, the representation includes the training dataset 230 in storage (e.g., a memory of the memory device 140) and the cache 160.

A request 510 for training data from the cache 160 includes a first instance 512 of training data, a second instance 513 of training data, a third instance 514 of training data, and a fourth instance 515 of training data. In some embodiments, the request 510 for training data from the cache 160 originates from the second stage 204. For instance, the request 510 for training data may be transmitted from the second stage 204 before the collate batch operation 218. In some embodiments, the data sampler 410 randomly requests the first, second, third, and fourth instances 512-515 of training data from the cache 160. As shown, the cache 160 includes instances 522-526 of training data and the use count 430 includes counts 532-536 for the instances 522-526 of training data, respectively.

In FIG. 5A, the use count eviction 440 is not marked for any of the instances 522-526 of training data. In some embodiments, the use count eviction 440 may be marked by the compute device 150 for one of the instances 522-526 of training data if a corresponding one of the counts 532-536 reaches a predefined threshold (e.g., a number of training jobs). As illustrated in FIG. 5A, the use status indicator 420 includes an instance 520 of training data that has been used to train the first and second machine learning models 170-1, 170-2 in an epoch. Accordingly, the instance 520 of training data should not be reused during the epoch.

As shown in FIG. 5A, first instance 512 of training data in the request 510 is not included in the cache 160 because the first instance 512 of training data does not match any of the instances 522-526 of training data included in the cache 160. In the illustrated example, the request for the first instance 512 of training data “misses” the cache 160. However, the second instance 513 of training data in the request 510 is included in the cache 160 because the second instance 513 of training data matches the instance 523 of training data which is included in the cache 160. Thus, in FIG. 5A, the request for the second instance 513 of training data “hits” the cache 160.

Similarly, the third and fourth instances 514, 515 of training data in the request 510 are included in cache 160 since the third and fourth instances 514, 515 of training data match the instances 524, 525, respectively. Accordingly, the requests for the second, third, and fourth instances 513-515 of training data “hit” the cache 160 while the request for the first instance 512 of training data “misses” the cache 160. For instance, a cache 160 miss is identified for the first instance 512 of training data. It is to be appreciated that, in some embodiments, although the cache 160 does not include the first instance 512 of training data in the request 510, the cache 160 does include the instance 522 and the instance 526 of training data.

In some embodiments, the first instance 512 of training data requested may be replaced with the instance 522 or the instance 526 of training data. Although the data sampler 410 randomly requests the first instance 512 of training data in order to generate a random order of training data samples for training the first and second machine learning models 170-1, 170-2, replacing the first instance 512 with a different instance of training data may maintain the random order for the training data samples. However, the different instance of training data should be used once per epoch and the different instance of training data should not be reused across epochs.

As shown in FIG. 5A, the instance 522 of training data matches the instance 520 of training data included in the use status indicator 420. Accordingly, the instance 522 of training data should not be used to replace the requested first instance 512 of training data because the instance 522 has been used once in an epoch for training the first and second machine learning models 170-1, 170-2. The instance 526 of training data does not match any instances of training data included in the use status indicator 420. Thus, the instance 526 of training data has not been used in the epoch for training the first and second machine learning models 170-1, 170-2 and the instance 526 of training data may be used to replace the requested first instance 512 of training data.

FIG. 5B illustrates a representation of a response 550 to a request 510 for training data according to embodiments of the disclosure. As shown, a response 550 to the request 510 includes the second instance 513, the third instance 514, and the fourth instance 515 of the training data which are included in the cache 160 upon receipt of the request 510. As further shown, the count 533 for the instance 523 of training data (that matches the second instance 513 of training data) is incremented from 2 in FIG. 5A to 3 in FIG. 5B. Similarly, the counts 534, 535 for the instances 524, 525 of training data are incremented to 2 and 5, respectively.

As illustrated in FIG. 5B, the count 535 has reached the predefined threshold number of uses for eviction from the cache 160 (e.g., the predefined threshold number of uses may be 5). As a result, the instance 525 of training data is marked 570 for eviction in the use count eviction 440 and a background thread is configured to remove the instance 525 of training data from the cache 160. In some embodiments, the background thread is also configured to add a new instance of training data from the training dataset 230 to the cache 160 in order to replace the instance 525 of training data evicted from the cache 160.

As described above, the first instance 512 of training data included in the request 510 “misses” the cache 160 because the first instance 512 does not match any of the instances 522-526 of training data included in the cache 160. Since the first instance 512 of training data is not available in the cache 160, the instance 526 of training data may be used to replace the requested first instance 512 of training data. As shown, the response 550 includes an instance 552 of training data which matches the instance 526 of training data. As further shown, the count 536 is incremented for the instance 526 of training data in the cache 160 from 1 in FIG. 5A to 2 in FIG. 5B.

In the illustrated example, the use status indicator 420 includes instances 562-565 of training data which are each used once in an epoch for training the first and second machine learning models 170-1, 170-2. As shown, the instances 562-565 of training data match the instances 552, 513-515 of training data, respectively. By including the instances 562-565 of training data in the use status indicator 420, the instances 562-565 of training data are not reused in the epoch. It is to be appreciated that, in some embodiments, the use status indicator 420 may be reset after training the first and second machine learning models 170-1, 170-2 to perform a task in the epoch.

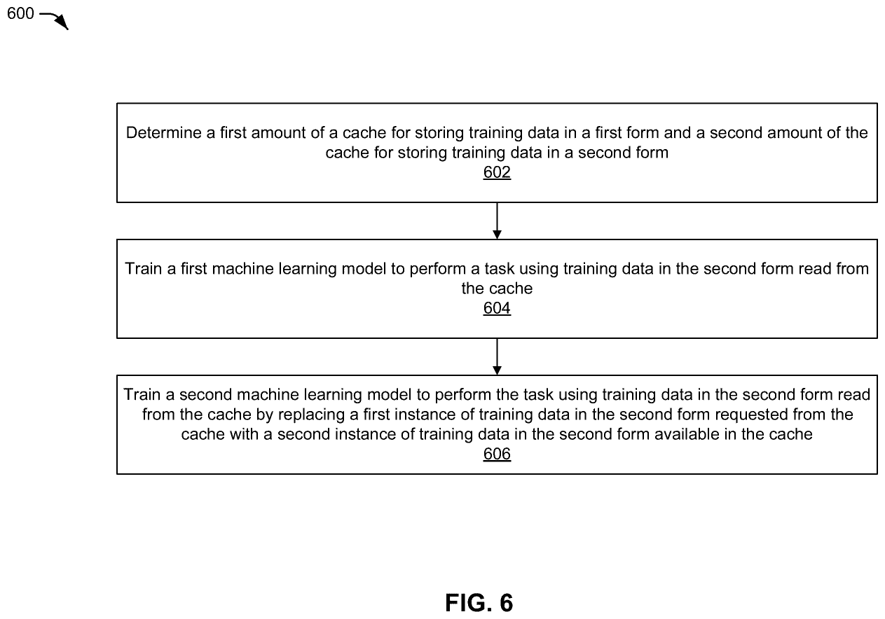

FIG. 6 shows a flowchart of an example procedure 600 for training a first machine learning model 170-1 to perform a task and training a second machine learning model 170-2 to perform the task, according to embodiments of the disclosure. At block 602, a first amount of a cache 160 for storing training data in a first form and a second amount of the cache 160 for storing training data in a second form are determined. In some embodiments, a relationship between throughput 302 of the data storage and ingestion pipeline 200 and an amount of each of the encoded training data 310, the decoded training data 312, and the augmented training data 314 included in the cache 160 may be based on one or more characteristics of the memory device 140 (e.g., a memory capacity), the compute device 150 (e.g., CPU/GPU availability), the training dataset 230 (e.g., a size, a total number of samples, an average size of samples, or other training dataset 230 characteristics), the first and second machine learning models 170-1, 170-2 (e.g., model size/type), the network 145 (e.g., network bandwidth), and/or other systems/devices. At block 604, a first machine learning model 170-1 is trained to perform a task using training data in the second form read from the cache 160. At block 606, a second machine learning model 170-2 is trained to perform the task using training data in the second form read from the cache 160 by replacing a first instance of training data in the second form requested from the cache 160 with a second instance of training data in the second form available in the cache 160. In some embodiments, the train operation 220 is performed to train the first and second machine learning models 170-1, 170-2 to perform the task.

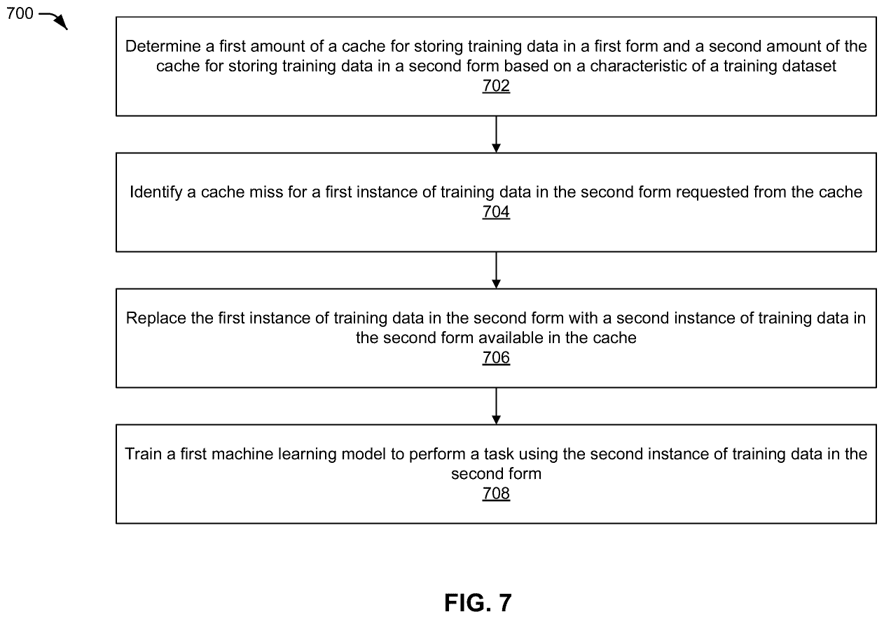

FIG. 7 shows a flowchart of an example procedure 700 for training a first machine learning model to perform a task, according to embodiments of the disclosure. At block 702, a first amount of a cache 160 for storing training data in a first form and a second amount of the cache 160 for storing training data in a second form are determined based on a characteristic of a training dataset 230. In some embodiments, characteristics of the training dataset 230 may include a type of training data (e.g., digital images, text, digital video, digital audio, or other types), whether or not training samples are labeled, whether the training dataset 230 is static (e.g., fixed) or dynamic (e.g., changing/increasing), a dimensionality of the training dataset 230 (e.g., a number of features per training sample), a data distribution of the training dataset 230 (e.g., a number of classes/distributions), and other characteristics. At block 704, a cache miss is identified for a first instance of training data in the second form requested from the cache 160. At block 706, the first instance of training data in the second form is replaced with a second instance of training data in the second form available in the cache 160. At block 708, a first machine learning model 170-1 is trained to perform a task using the second instance of training data in the second form. In some embodiments, the train operation 220 is performed using a batch of training data to train the first and second machine learning models 170-1, 170-2 to perform the task.

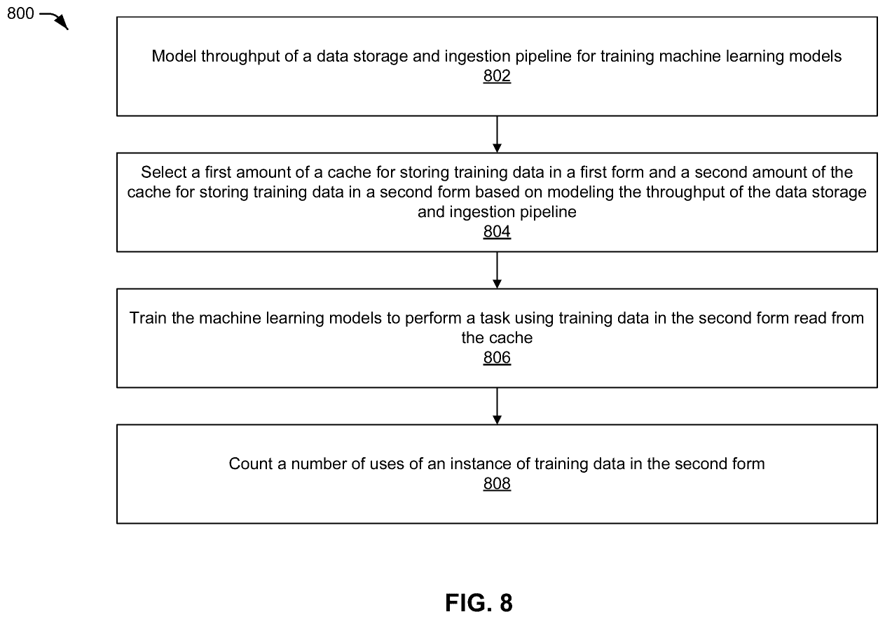

FIG. 8 shows a flowchart of an example procedure 800 for training machine learning models to perform a task, according to embodiments of the disclosure. At block 802, throughput 302 of a data storage and ingestion pipeline 200 for training machine learning models 170-1, 170-2 is modeled. In some embodiments, throughput 302 (samples per second) of the data storage and ingestion pipeline 200 is based on a multivariate and non-linear corresponding with amounts of the encoded training data 310, the decoded training data 312, and the augmented training data 314 included in the data storage and ingestion pipeline 200. At block 804, a first amount of a cache 160 for storing training data in a first form and a second amount of the cache 160 for storing training data in a second form are selected based on modeling the throughput 302 of the data storage and ingestion pipeline 200. At block 806, the machine learning models 170-1, 170-2 are trained to perform a task using training data in the second form read from the cache 160. At block 808, a number of uses of an instance of training data in the second form is counted. In some embodiments, the compute device 150 executes instructions which cause the compute device 150 to count the number of uses of the instance of training data in the second form.

In FIGS. 6-8, some embodiments of the disclosure are shown. But a person skilled in the art will recognize that other embodiments of the disclosure are also possible, by changing the order of the blocks, by omitting blocks, or by including links not shown in the drawings. All such variations of the flowcharts are considered to be embodiments of the disclosure, whether expressly described or not.

The following discussion is intended to provide a brief, general description of a suitable machine or machines in which certain aspects of the disclosure may be implemented. The machine or machines may be controlled, at least in part, by input from conventional input devices, such as keyboards, mice, and other input devices, as well as by directives received from another machine, interaction with a virtual reality (VR) environment, biometric feedback, or other input signal. As used herein, the term “machine” is intended to broadly encompass a single machine, a virtual machine, or a system of communicatively coupled machines, virtual machines, or devices operating together. Exemplary machines include computing devices such as personal computers, workstations, servers, portable computers, handheld devices, telephones, tablets, and other machines, as well as transportation devices, such as private or public transportation, e.g., automobiles, trains, cabs, and other transportation devices.

The machine or machines may include embedded controllers, such as programmable or non-programmable logic devices or arrays, application specific integrated circuits (ASICs), embedded computers, smart cards, and the like. The machine or machines may utilize one or more connections to one or more remote machines, such as through a network interface, modem, or other communicative coupling. Machines may be interconnected by way of a physical and/or logical network, such as an intranet, the Internet, local area networks, wide area networks, and other networks. One skilled in the art will appreciate that network communication may utilize various wired and/or wireless short range or long range carriers and protocols, including radio frequency (RF), satellite, microwave, Institute of Electrical and Electronics Engineers (IEEE) 802.11, Bluetooth®, optical, infrared, cable, laser, and other carriers/protocols.

Embodiments of the present disclosure may be described by reference to or in conjunction with associated data including functions, procedures, data structures, application programs, and other data, which when accessed by a machine results in the machine performing tasks or defining abstract data types or low-level hardware contexts. Associated data may be stored in, for example, the volatile and/or non-volatile memory, e.g., random access memory (RAM), read only memory (ROM), and other memories, or in other storage devices and their associated storage media, including hard-drives, floppy-disks, optical storage, tapes, flash memory, memory sticks, digital video disks, biological storage, and other devices/media. Associated data may be delivered over transmission environments, including the physical and/or logical network, in the form of packets, serial data, parallel data, propagated signals, and other forms of transmission, and may be used in a compressed or encrypted format. Associated data may be used in a distributed environment, and stored locally and/or remotely for machine access.

Embodiments of the disclosure may include a tangible, non-transitory machine-readable medium comprising instructions executable by one or more processors, the instructions comprising instructions to perform the elements of the disclosures as described herein.

The various operations of methods described above may be performed by any suitable means capable of performing the operations, such as various hardware and/or software component(s), circuits, and/or module(s). The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or steps of a method or algorithm and functions described in connection with the embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in random access memory (RAM), flash memory, read only memory (ROM), electrically programmable ROM (EPROM), electrically erasable programmable ROM (EEPROM), registers, hard disk, a removable disk, or any other form of storage medium known in the art.

Having described and illustrated the principles of the disclosure with reference to illustrated embodiments, it will be recognized that the illustrated embodiments may be modified in arrangement and detail without departing from such principles, and may be combined in any desired manner. And, although the foregoing discussion has focused on particular embodiments, other configurations are contemplated. In particular, even though expressions such as “according to an embodiment of the disclosure” or the like are used herein, these phrases are meant to generally reference embodiment possibilities, and are not intended to limit the disclosure to particular embodiment configurations. As used herein, these terms may reference the same or different embodiments that are combinable into other embodiments.

The foregoing illustrative embodiments are not to be construed as limiting the disclosure thereof. Although a few embodiments have been described, those skilled in the art will readily appreciate that many modifications are possible to those embodiments without materially departing from the novel teachings and advantages of the present disclosure. Accordingly, all such modifications are intended to be included within the scope of this disclosure as defined in the claims.

Consequently, in view of the wide variety of permutations to the embodiments described herein, this detailed description and accompanying material is intended to be illustrative only, and should not be taken as limiting the scope of the disclosure. What is claimed as the disclosure, therefore, is all such modifications as may come within the scope and spirit of the following claims and equivalents thereto.

What is claimed is:

1. A non-transitory computer-readable storage medium storing instructions that, responsive to execution by a processor, cause the processor to perform operations comprising:
determining an amount of a cache for storing training data in a particular form based on modeling throughput of a data storage and ingestion pipeline for training machine learning models; and
training the machine learning models to perform a task using training data in the particular form stored in the cache by:
identifying a request for a first instance of the training data in the particular form to include in a training batch, wherein the first instance of the training data in the particular form is not stored in the cache;
determining a second instance of the training data in the particular form stored in the cache has not been used to train the machine learning models; and
including the second instance of the training data in the particular form in the training batch.

2. The non-transitory computer-readable storage medium according to claim 1, wherein determining the second instance of the training data in the particular form has not been used to train the machine learning models is based on a use status indicator for the second instance of the training data in the particular form.

3. The non-transitory computer-readable storage medium according to claim 2, wherein the operations further comprise setting the use status indicator after including the second instance of the training data in the particular form in the training batch.

4. The non-transitory computer-readable storage medium according to claim 3, wherein the operations further comprise:
completing a training epoch for the machine learning models; and
resetting the use status indicator based on completing the training epoch.

5. The non-transitory computer-readable storage medium according to claim 1, wherein determining the amount of the cache for storing the training data in the particular form is based on a characteristic of a training dataset comprising the training data.

6. The non-transitory computer-readable storage medium according to claim 5, wherein the characteristic of the training dataset includes at least one of a size of the training dataset, a number of samples included in the training dataset, or an average size of the samples included in the training dataset.

7. The non-transitory computer-readable storage medium according to claim 1, wherein the operations further comprise counting a number of uses of the second instance of the training data in the particular form.

8. The non-transitory computer-readable storage medium according to claim 7, wherein the operations further comprise marking the second instance of the training data in the particular form for eviction from the cache based on the number of uses.

9. A system comprising:
a cache;
a processor coupled to the cache, the processor configured to:
determine an amount of the cache for storing training data in a particular form based on a characteristic of a training dataset;
identify a request for a first instance of the training data in the particular form to include in a training batch, wherein the first instance of the training data in the particular form is not stored in the cache;
determine a second instance of the training data in the particular form stored in the cache has not been used to train a machine learning model;
include the second instance of the training data in the particular form in the training batch; and
train the machine learning model to perform a task using the training batch.

10. The system according to claim 9, wherein the processor is further configured to train an additional machine learning model to perform the task using the training batch.

11. The system according to claim 9, wherein the characteristic of the training dataset includes at least one of a size of the training dataset, a number of samples included in the training dataset, or an average size of the samples included in the training dataset.

12. The system according to claim 11, wherein the characteristic of the training dataset is used to model throughput of a data storage and ingestion pipeline for training the machine learning model.

13. The system according to claim 9, wherein the processor is further configured to determine the second instance of the training data in the particular form has not been used to train the machine learning model based on a use status indicator.

14. The system according to claim 13, wherein the processor is further configured to set the use status indicator based on training the machine learning model to perform the task using the training batch.

15. The system according to claim 14, wherein the processor is further configured to:
complete a training epoch for the machine learning model; and
reset the use status indicator based on completing the training epoch for the machine learning model.

16. The system according to claim 9, wherein the processor is further configured to:
count a number of uses of the second instance of the training data in the particular form; and
mark the second instance of the training data in the particular form for eviction from the cache based on the number of uses.

17. A method comprising:
modeling throughput of a data storage and ingestion pipeline for training machine learning models;
selecting an amount of a cache for storing training data in a particular form based on modeling the throughput of the data storage and ingestion pipeline; and
training the machine learning models to perform a task using the training data in the particular form stored in the cache by:
identifying a request for a first instance of the training data in the particular form to include in a training batch, wherein the first instance of the training data in the particular form is not stored in the cache;
determining a second instance of the training data in the particular form stored in the cache has not been used to train the machine learning models; and
including the second instance of the training data in the particular form in the training batch.

18. The method according to claim 17, further comprising:
counting a number of uses of the second instance of the training data in the particular form; and
marking the second instance of the training data in the particular form for eviction from the cache based on the number of uses.

19. The method according to claim 17, wherein modeling the throughput of the data storage and ingestion pipeline is based on at least one of a size of a training dataset, a number of samples included in the training dataset, or an average size of the samples included in the training dataset.

20. The method according to claim 17, further comprising:
completing a training epoch for the machine learning models; and
resetting a use status indicator for the second instance of the training data in the particular form based on completing the training epoch.
